(19) United States
(12) Patent Application Publication
(10) Pub. No.: US 2024/0260670 A1
(43) Pub. Date: Aug. 8, 2024

(54) Aerosol Generating Device

(71) Applicant: JT International SA, GENEVA (CH)

(72) Inventor: Herman Hijma, Kampen (NL)

(73) Assignee: JT International SA, Geneva (CH)

(21) Appl. No.: 18/275,324

(22) PCT Filed: Jan. 26, 2022
(86) PCT No.: PCT/EP2022/051761

§ 371 Date: Aug. 1, 2023

(30) Foreign Application Priority Data
Feb. 2, 2021 (EP) 21154830.0

(51) Int. Cl. A24F 40/465; A24F 40/20; H05B 6/10

(52) U.S. Cl. CPC A24F 40/465; A24F 40/20; H05B 6/105

(57) ABSTRACT

A heating apparatus for an aerosol generating device includes: a heating chamber for receiving an aerosol generating substrate; and a susceptor assembly comprising including a support and a plurality of susceptor branches extending from the support, the support is positioned proximate a first end of the heating chamber and the plurality of susceptor branches extend toward a second end of the heating chamber. An aerosol generating system includes the heating apparatus in combination with an aerosol generating article.

### FIELD OF THE INVENTION

The present disclosure relates to an aerosol generating device. Such devices heat, rather than burn, an aerosol generating substrate, e.g., tobacco or other suitable materials, by conduction, convention, and/or radiation to generate an aerosol for inhalation by a user. The present disclosure is particularly applicable to a heating apparatus for an aerosol generating device.

### BACKGROUND

The popularity and use of reduced-risk or modified-risk devices (also known as aerosol generating devices or vapour generating devices) has grown rapidly in recent years as an alternative to the use of traditional tobacco products. Various devices and systems are available that heat or warm aerosol generating substances to generate an aerosol for inhalation by a user.

A commonly available reduced-risk or modified-risk device is the heated substrate aerosol generating device, or so-called heat-not-burn device. Devices of this type generate an aerosol or vapour by heating an aerosol generating substrate to a temperature typically in the range 150° C. to 300° C. Heating the aerosol generating substrate to a temperature within this range, without burning or combusting the aerosol generating substrate, generates a vapour which typically cools and condenses to form an aerosol for inhalation by a user of the device.

Currently available aerosol generating devices can use one of a number of different approaches to provide heat to the aerosol generating substrate. One such approach is to provide an aerosol generating device which employs an induction heating system. In such a device, an induction coil is provided in the device and an inductively heatable susceptor is provided to heat the aerosol generating substrate. Electrical energy is supplied to the induction coil when a user activates the device which in turn generates an alternating electromagnetic field. The susceptor couples with the electromagnetic field and generates heat which is transferred, for example by conduction, to the aerosol generating substrate and an aerosol is generated as the aerosol generating substrate is heated.

An object of the invention is to provide a more versatile aerosol generating device.

### SUMMARY OF THE INVENTION

According to the present invention there is provided a heating apparatus for an aerosol generating device comprising: a heating chamber comprising an opening arranged at a first end of the heating chamber for receiving an aerosol generating substrate; and a susceptor assembly comprising a support and a plurality of susceptor branches extending from the support, wherein, in use, the support is positioned proximate the first end of the heating chamber and the plurality of susceptor branches extend toward a second end of the heating chamber.

In this way a plurality of susceptor branches can be connected to a support, or frame, structure to form a group of susceptors. Advantageously this simplifies the manufacture of the susceptor assembly and heating apparatus. The grouped susceptor construction allows the heating element to be easily provided, or installed, into the heating chamber as a single unit, or unitary structure. The nature of the susceptor assembly/heating component also allows different susceptor assembly configurations to be used with the heating chamber. For example, different susceptor assemblies may have varying numbers or shapes of susceptor branches in order to vary the heat generation or delivery to a received aerosol generating substrate. Using a plurality of susceptor branches also optimises heat distribution from each branch to an inserted aerosol generating substrate/consumable. For instance each susceptor branch will generate heat and reach a desired temperature more rapidly than a cylindrical or solid internal rod type susceptor for example, and thus transfer the generated heat to a consumable in a more efficient manner.

Preferably the support comprises a susceptor. In this way the support and branches can all be made from susceptor material, which advantageously simplifies the manufacture of the susceptor assembly. The support and the plurality of susceptor branches may be made from a single piece of susceptor material. Alternatively the susceptor branches may be individually attached to the support. The connection attachment may be a reinforced shaft.

Preferably the susceptor assembly is configured to be removable from the heating chamber, and further comprises a ring configured provide a frictional force which acts against an inner surface of the heating chamber, and wherein the support is arranged within the ring. In this way the susceptor assembly can be effectively retained in the heating chamber for use, and also allow easy removal of the susceptor assembly for cleaning/changing. The grouped susceptor construction allows the heating element to be easily removed from the heating chamber as a single unit, or unitary structure, for cleaning purposes. The susceptor assembly may be removed by taking hold of the support. The removable nature of the susceptor assembly/heating component also allows different susceptor assembly configurations to be used with the heating chamber. A sufficient frictional force is required between the susceptor assembly and the heating chamber to prevent the inadvertent extraction of the susceptor assembly when a spent aerosol generating substrate is removed/pulled out. The susceptor assembly may be configured to allow an aerosol generating substrate to pass through the ring. The ring may also separate the susceptor material, including if a support comprising susceptor material, from the heating chamber wall. The plurality of susceptor branches may extend out of the ring toward the second end of the heating chamber.

The ring may comprise a substantially non-electrically conductive and non-magnetically permeable material. In this way the heat generating by susceptors may be better contained within the heating chamber and delivered to a received aerosol generating substrate. The substantially non-electrically conductive and non-magnetically permeable material may be a polymer material. The heating chamber and/or ring may comprise a heat-resistant plastics material, such as polyether ether ketone (PEEK). In addition rings comprising the polymer material may be easily moulded over the susceptors. A susceptor assembly comprising a polymer material ring may also be readily pressed into the heating chamber to ensure a tight fit or seal against the interfacing surfaces.

Preferably the support is perforated and the ring is overmoulded on the perforated support. In this way the connection between the support and the ring is more secure. Advantageously by providing the support in an overmoulded ring, the susceptor material is better separated from the heating chamber wall, thereby further preventing undesired heat transfer out of the chamber.

Preferably each susceptor branch is configured to flex toward a wall of the heating chamber when the aerosol generating substrate is received in the heating chamber. In this way the susceptor branches provide a frictional force, or grip, on the received aerosol generating substrate, which reduces the risk of the substrate from inadvertently falling out of the device. The susceptor branches may be bent toward the longitudinal centreline of the heating chamber to provide a slight tension between the branches and the substrate. This can advantageously intensify contact between branches and the substrate for better heat transfer. The plurality of susceptor branches may be arranged in a tulip shape.

Preferably a length of each of the susceptor branches is angled such that each length extends inwardly toward a central axis of the heating chamber as the respective susceptor branch extends away from the support. In this way the susceptor branches are biased towards the central axis of the heating chamber such that cross-sectional area in which an aerosol generating substrate is received is smaller than the cross-sectional area of the heating chamber opening. In other words the susceptor branches are biased away from the inner wall of the heating chamber. This improves the grip on an aerosol generating substrate in the heating chamber, which reduces the risk of the substrate from inadvertently falling out of the device. In addition heat transfer, or heat loss, to the chamber wall is minimised by reducing contact between the susceptor branches and the chamber wall. In an example the angled length of each susceptor branch may extend along the majority, or entire length, of the portion of the branch that extends from the support. In this example the main length of each susceptor branch is angled relative to a wall of the heating chamber so as to extend each susceptor branch away from the heating chamber wall in a direction moving away from the support.

Preferably each susceptor branch comprises an abutment portion configured to maintain a separation between a wall of the heating chamber and the susceptor branch when the aerosol generating substrate is received in the heating chamber. In this way the main body of a susceptor branch can be removed, or kept away, from the heating chamber wall and there is minimal contact between the susceptor branch portions and the chamber wall. This provides a secure configuration for the susceptor branches as well as minimising heat loss. The abutment portion may provide a minimum separation distance, depending on the thickness of the aerosol generating substrate received in the chamber.

Preferably each susceptor branch comprises a ridge. In this way the ridge can provide an intensified contact between the susceptor branch and a received aerosol generating substrate at its crest in a configuration where the crest of the ridge points toward the centreline of the heating chamber. Alternatively in another configuration the crest points toward the heating chamber wall, and the slopes of the ridge provide a larger contact area with the received aerosol generating substrate. The ridge may be provided within a curved, or cupped portion of the susceptor branch to further reinforce the branch as well as intensify contact with a substrate.

Preferably one or more of the plurality of susceptor branches comprises a limiting portion configured to limit the depth to which the aerosol generating substrate can be received. In this way the limiting portion can act as an insertion limiter for the aerosol generating substrate so as to provide a gap between the closed end of the heating chamber and the inserted end of the substrate. In other words an aerosol generating substrate cannot extend beyond the limiting portion. The limiting portion may be arranged substantially perpendicular to the direction of insertion of the aerosol generating substrate. The insertion limiting portion may comprise a limb that extends radially inwardly with respect to the longitudinal axis of the heating chamber. The limiting portion allows air to better flow into the chamber flow around the outer surface of the aerosol generating substrate and be directed up and into the aerosol generating substrate via the distal/inserted end of the substrate. One or more of the susceptor branches may also comprise an extended portion configured to abut the closed end of the heating chamber. This advantageously prevents the susceptor assembly from being inserted too deeply or too tightly into the heating chamber.

Preferably the heating chamber comprises a protrusion configured to prevent an aerosol generating substrate from reaching a closed end of the heating chamber. In this way the protrusion creates a distance between the inserted end of the aerosol generating substrate and the closed end of the heating chamber such that the air flow in the heating chamber into the inserted end of the substrate is not restricted.

Preferably the heating chamber comprises a chamber wall configured to support an induction heating coil of an electromagnetic field generator. The chamber wall may include a coil support structure which may be formed in or on an outer surface for supporting an induction heating coil of an electromagnetic field generator. The coil support structure facilitates mounting of the induction heating coil and allows the induction heating coil to be positioned optimally with respect to the susceptor assembly. The susceptors are, therefore, heated efficiently, thereby improving the energy efficiency of the heating apparatus. The provision of the coil support structure also facilitates manufacture and assembly of the heating apparatus.

According to another aspect of the invention there is provided an aerosol generating system comprising: an aerosol generating substrate; an electromagnetic field generator; and a heating apparatus according to the first aspect.

### BRIEF DESCRIPTION OF THE DRAWINGS

Embodiments of the invention are described below by way of example with reference to the drawings, in which:

FIG. 1A is a schematic cross-sectional view of an aerosol generating system according to a first embodiment of the invention, the aerosol generating system comprising a heating apparatus according to the invention, and an aerosol generating substrate for inserting into the heating apparatus;

FIG. 1B is a schematic cross-sectional view of the aerosol generating system of FIG. 1A, showing the aerosol generating substrate positioned in the heating apparatus;

FIG. 2A is a top view of a susceptor assembly according to a second embodiment of the invention;

FIG. 2B is a side view of the susceptor assembly of the second embodiment of the invention;

FIG. 2C is a schematic view of the susceptor assembly of the second embodiment of the invention;

FIG. 2D is a side view of a heating apparatus according to the second embodiment of the invention;

FIG. 3A is a side view of another susceptor assembly according to a third embodiment of the invention;

FIG. 3B is a schematic view of the susceptor assembly according to the third embodiment of the invention;

FIG. 3C is a side view of a heating apparatus according to the third embodiment of the invention;

FIG. 4A is a side view of another susceptor assembly according to a fourth embodiment of the invention;

FIG. 4B is a mid-section view of the susceptor assembly of the fourth embodiment of the invention;

FIG. 4C is a schematic view of the susceptor assembly of the fourth embodiment of the invention;

FIG. 4D is a side view of a heating apparatus according to the fourth embodiment of the invention;

FIG. 5A is a schematic view of a susceptor branch upper section according to a fifth embodiment of the invention;

FIG. 5B is a mid-section view of the susceptor assembly of the fifth embodiment of the invention;

FIG. 5C is a schematic view of the susceptor assembly of the fifth embodiment of the invention;

FIG. 5D is a side view of a heating apparatus according to the fifth embodiment of the invention;

FIG. 6A is a schematic view of another susceptor assembly according to a sixth embodiment of the invention;

FIG. 6B is an end-on view of the susceptor assembly of the sixth embodiment of the invention;

FIG. 7A is a schematic view of another susceptor assembly according to a seventh embodiment of the invention;

FIG. 7B is a schematic of a heating apparatus of the seventh embodiment of the invention;

FIG. 8A is a schematic view of a heating chamber according to an embodiment of the invention; and

FIG. 8B is a schematic of a heating chamber according to another embodiment of the invention.

### DETAILED DESCRIPTION

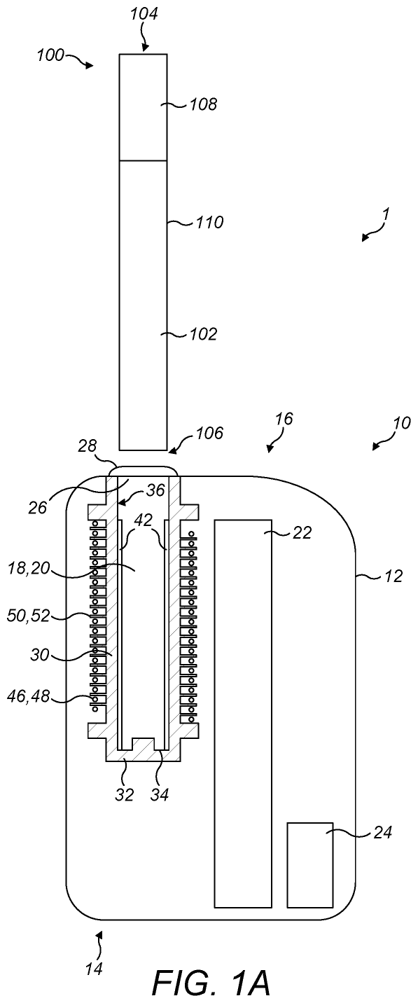

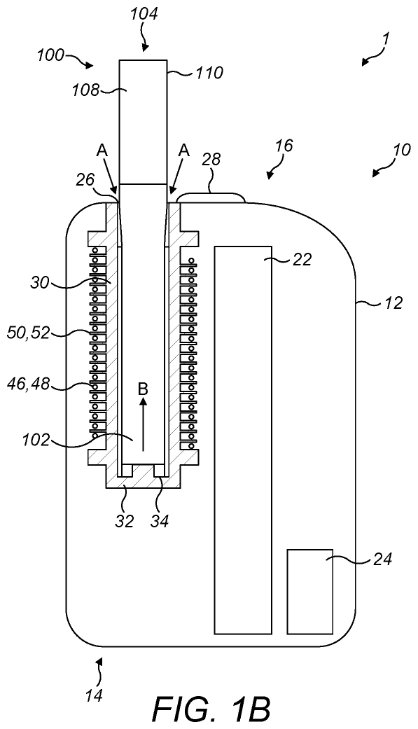

FIGS. 1A and 1B show an aerosol generating system 1, which comprises an aerosol generating device 10 and an aerosol generating article 100 for use with the device 10. The aerosol generating device 10 comprises a main body 12 housing various components of the aerosol generating device 10. The main body 12 can have any shape that is sized to fit the components described in the various embodiments set out herein and to be comfortably held by a user unaided, in a single hand.

A first end 14 of the aerosol generating device 10, shown towards the bottom of FIGS. 1A and 1B, is described for convenience as a distal, bottom, base or lower end of the aerosol generating device 10. A second end 16 of the aerosol generating device 10, shown towards the top of FIGS. 1a and 1b, is described as a proximal, top or upper end of the aerosol generating device 10. During use, the user typically orients the aerosol generating device 10 with the first end 14 downward and/or in a distal position with respect to the user's mouth and the second end 16 upward and/or in a proximate position with respect to the user's mouth.

The aerosol generating device 10 comprises a heating chamber 18 positioned in the main body 12. The heating chamber 18 defines an interior volume in the form of a cavity 20 having a substantially cylindrical cross-section for receiving an aerosol generating article 100. The heating chamber 18 has a longitudinal axis defining a longitudinal direction and is formed of a heat-resistant plastics material, such as polyether ether ketone (PEEK). The aerosol generating device 10 further comprises a power source 22, for example one or more batteries which may be rechargeable, and a controller 24.

The heating chamber 18 is open towards the second end 16 of the aerosol generating device 10. In other words, the heating chamber 18 has an open first end 26 towards the second end 16 of the aerosol generating device 10. The heating chamber 18 is typically held spaced apart from the inner surface of the main body 12 to minimise any heat transfer to the main body 12.

The aerosol generating device 10 can optionally include a sliding cover 28 movable transversely between a closed position (see FIG. 1A) in which it covers the open first end 26 of the heating chamber 18 to prevent access to the heating chamber 18 and an open position (see FIG. 1B) in which it exposes the open first end 26 of the heating chamber 18 to provide access to the heating chamber 18.

The heating chamber 18, and specifically the cavity 20, is arranged to receive a correspondingly shaped generally cylindrical or rod-shaped aerosol generating article 100. Typically, the aerosol generating article 100 typically comprises a pre-packaged aerosol generating substrate 102. The aerosol generating article 100 is a disposable and replaceable article (also known as a “consumable”) which may, for example, contain tobacco as the aerosol generating substrate 102. The aerosol generating article 100 has a proximal end 104 (or mouth end) and a distal end 106. The aerosol generating article 100 further comprises a mouthpiece segment 108 positioned downstream of the aerosol generating substrate 102. The aerosol generating substrate 102 and the mouthpiece segment 108 are arranged in coaxial alignment inside a wrapper 110 (e.g., a paper wrapper) to hold the components in position to form the rod-shaped aerosol generating article 100.

The heating chamber 18 has a side wall (or chamber wall) 30 extending between a base 32, located at a second end 34 of the heating chamber 18, and the open first end 26. The side wall 30 and the base 32 are connected to each another and can be integrally formed as a single piece. In FIGS. 1A and 1B, the side wall 30 is tubular and, more specifically, cylindrical. In other examples, the side wall 30 can have other suitable shapes, such as a tube with an elliptical or polygonal cross section. The side wall 30 can also be tapered.

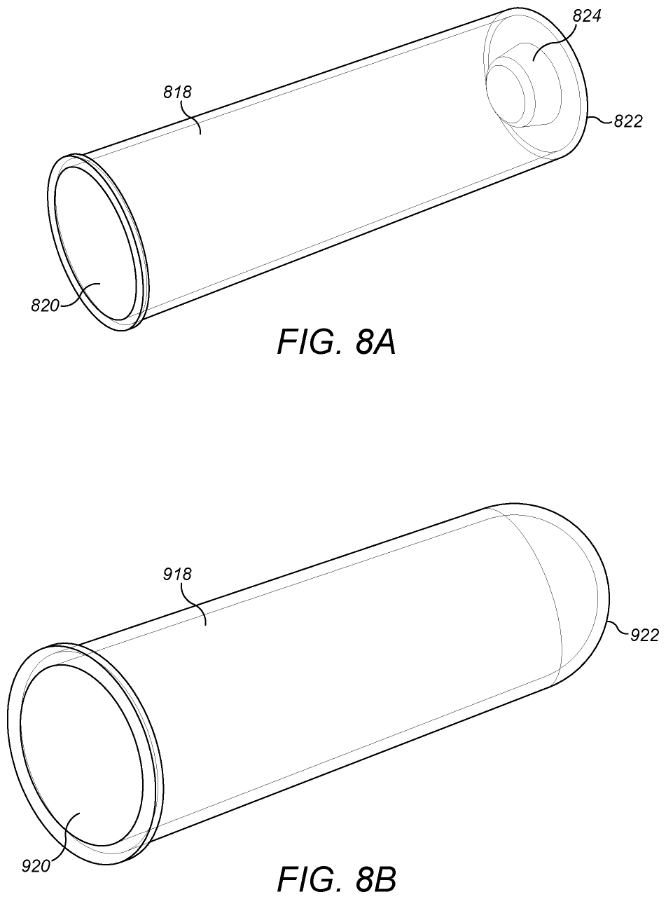

The base 32 of the heating chamber 18 is closed, e.g. sealed or air-tight. That is, the heating chamber 18 is cup-shaped. This can ensure that air drawn from the open first end 26 is prevented by the base 32 from flowing out of the second end 34 and is instead guided through the aerosol generating substrate 102, back up toward a user. It can also ensure that a user inserts the aerosol generating article 100 into the heating chamber 18 an intended distance and no further. FIG. 8 shows alternative heating chamber bases.

The side wall 30 of the heating chamber 18 has an inner surface 36 and an outer surface 38. The aerosol generating device 10 comprises an electromagnetic field generator 46 for generating an electromagnetic field. The electromagnetic field generator 46 comprises a substantially helical induction coil 48. The induction coil 48 has a circular cross-section and extends helically around the substantially cylindrical heating chamber 18. The induction coil 48 can be energised by the power source 22 and controller 24. The controller 24 includes, amongst other electronic components, an inverter which is arranged to convert a direct current from the power source 22 into an alternating high-frequency current for the induction coil 48.

The side wall 30 of the heating chamber 18 includes a coil support structure 50 formed in the outer surface 38. In the illustrated example, the coil support structure 50 comprises a coil support groove 52 which extends helically around the outer surface 38. The induction coil 48 is positioned in the coil support groove 52 and is, thus, securely and optimally positioned with respect to a susceptor assembly 42.

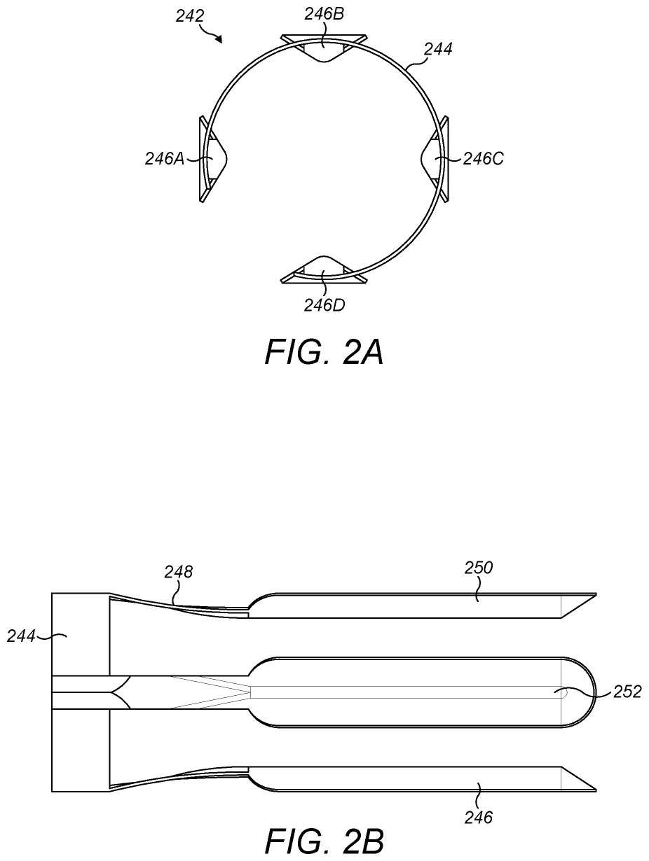

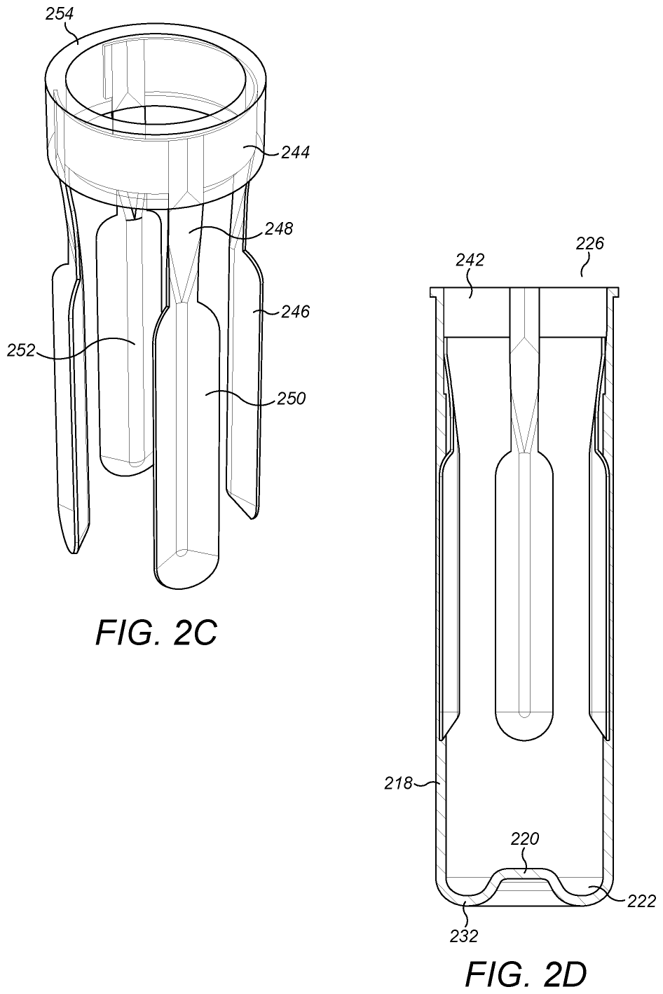

FIGS. 2 to 7 illustrate different embodiments of a removable susceptor assembly of the present invention suitable to be positioned within the heating chamber 18 of FIGS. 1A and 1B.

FIGS. 2A to 2D show various views of a susceptor assembly 242 according to an embodiment of the invention. FIGS. 2A and 2B show a top and side view of the susceptor assembly 242 respectively, FIG. 2C shows a perspective view of the susceptor assembly 242, and FIG. 2D shows a side view of the susceptor assembly 242 within a heating chamber 218.

The susceptor assembly 242 comprises a support 244, or frame, and four inductively heatable susceptor branches 246A, 246B, 246C, 246D extending from the support 244. The branches 246A, 246B, 246C, 246D are evenly spaced across the length of the support 244, and the support 244 is shaped into an open circle or C-shape when viewed from above (as in FIG. 2A), such that the branches 246A, 246B, 246C, 246D are circumferentially spaced around the open circle, where two branches 246A/246C and 246B/246D face each other on opposite sides of the open circle.

As can be seen in FIG. 2D the susceptor assembly 242 is positioned within the heating chamber 218 such that the support 244 is arranged at the open end 226 of the heating chamber 218 and the branches 246A, 246B, 246C, 246D extend away from the open end 226 towards the base 232 of the heating chamber 218. In other words the susceptor branches 246A, 246B, 246C, 246D are elongate in the longitudinal direction of the heating chamber 218. The base 232 of the heating chamber 218 comprises a protrusion 220 in the centre of the base 232 that extends inwardly into the heating chamber 218. The protrusion 220 acts as an insertion limiter for an aerosol generating substrate/article 100 that is received into the chamber 218 such that a gap 222 between the distal end 106 of the article 100 and the main base wall 232 is provided to allow air drawn into the heating chamber 218 to travel along the outer surface of the article 100 toward the base 232 to return up through the article 100 via the distal end 106 of the aerosol generating article 100.

Each of the susceptor branches 246A, 246B, 246C, 246D comprises a stem portion 248 and a blade portion 250. The stems 248 are mounted on the support 244 to connect the blades 250 of each susceptor branch 246 to the support 244 such that the susceptor assembly 244 is a unitary susceptor piece. The support 244 is also made from the same inductively heatable material as the branches 246A, 246B, 246C, 246D, and on activation of the aerosol generating device 10 by a user will generate heat to vaporise the aerosol generating substrate 102. In other example the support 244 may be made of a different material. In yet another example the support 244 and the branches 246A, 246B, 246C, 246D are cut from a same piece of susceptor material and stamped and bent into the desired shape.

The stem portions 248 are angled inwardly toward the central longitudinal axis of the heating chamber 218 along the direction extending away from the support 244 to bring the blade portions 250 away from the inner surface of the heating chamber 218 side wall. This provides a smaller cross-sectional area to receive the aerosol generating article 100 and thus provide a biasing grip force on an article 100 in the assembly 242. The blades 250 are arranged parallel to the longitudinal axis of the heating chamber 218 and each other. The ends of the blades 250 have a semi-circular curved edge/end for each susceptor branch 246, which reduces tearing of the aerosol generating article outer surface as it is extracted from the heating chamber 218.

The blade portion 250 of each susceptor branch 246A, 246B, 246C, 246D extends outwardly away from the central longitudinal axis of the heating chamber 218 toward the side wall of the heating chamber 218, such that an elongate ridge 252 is provided along the centre of each blade 250. The crest of the ridge 252 points inwardly toward the central longitudinal axis of the heating chamber 218. The stem-end of the ridge 252, toward the support 244, extends partially into each stem portion 248, and the distal end of the ridge 252, away the support 244, terminates away from the end of the respective blade 250 such that the blade end forms a quarter-dome shape.

The susceptor assembly 242 further comprises an outer ring 254 within which the support 244 is encased thereby provided a fully circular ring-shaped cross-section, as shown in FIG. 2C. The outer ring 254 is made of a polymeric material that is substantially non-electrically conductive and non-magnetically permeable, such as polyether ether ketone (PEEK). When the susceptor assembly 242 is pressed into the heating chamber 218, the outer ring 254 provides a friction fit around its entire outer periphery with the side wall of the heating chamber 218. The susceptor assembly 242 can be readily removed from the heating chamber 218 by pulling on the outer ring 254. In use an aerosol generating article 100 is inserted into the heating chamber 218 through the central opening of the outer ring 254. The outer ring 254 comprises venting gates (not shown) to allow air to pass through the body of the ring 254 when an aerosol generating article 100 is in the susceptor assembly 242 and a user inhales.

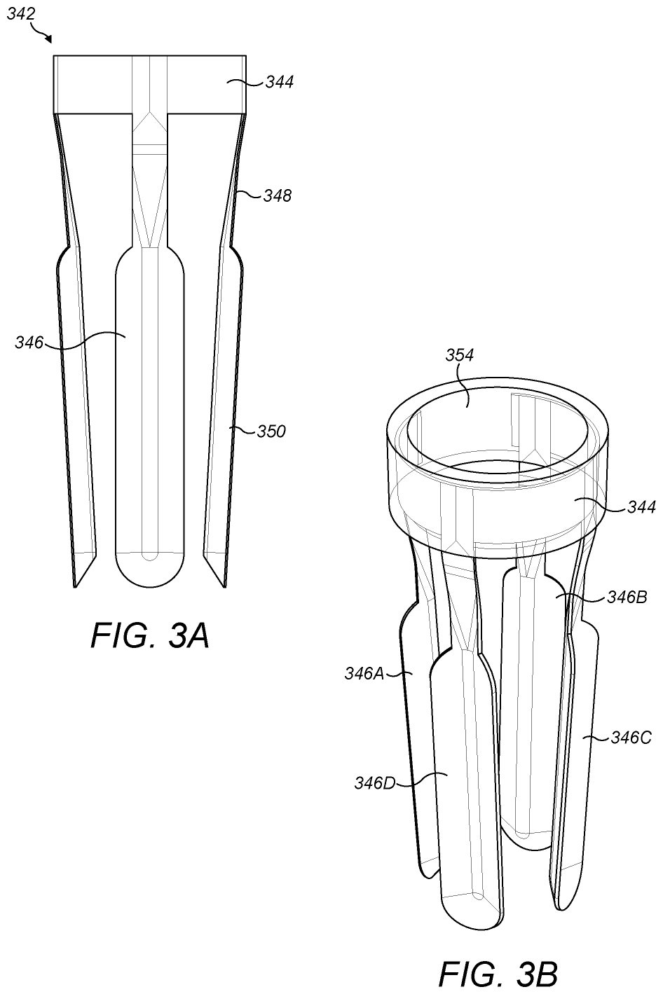

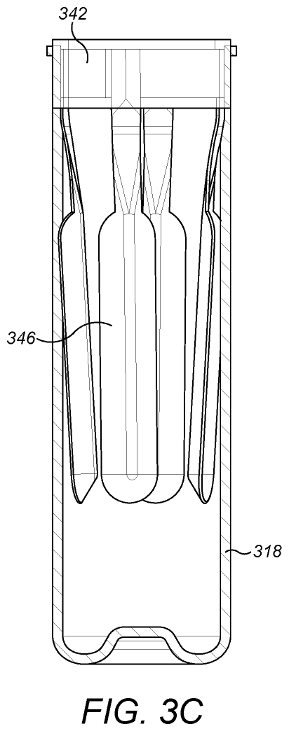

FIGS. 3A to 3C show various views of a susceptor assembly 342 according to another embodiment of the invention. FIG. 3A shows a side view of the susceptor assembly 342, FIG. 3B shows a perspective view of the susceptor assembly 342, and FIG. 3C shows a side view of the susceptor assembly 342 within a heating chamber 318.

The susceptor assembly 342 construction in FIG. 3 is similar to the embodiment described with reference to FIG. 2. The susceptor assembly 342 comprises a support 344 on which susceptor branches 346A, 346B, 346C, 346D are connected. Each susceptor branch 346 comprises a stem portion 348 and a blade portion 350.

As can be seen more clearly in FIG. 3A, the blades 350 of each susceptor branch 346, in a resting state (i.e. with no aerosol generating article/stick received within) are also angled relative to the central longitudinal axis of the susceptor assembly/heating chamber (as opposed to being parallel to the central axis as in FIG. 2). In an example when an aerosol generating article 100 is inserted into the susceptor assembly 342, the branches 346 flex outwardly toward the side wall of the heating chamber 318 to be parallel with the heating chamber side wall. To put it in another way, in the relaxed/resting state (when no aerosol generating article is held within the susceptor assembly 342), the angle α of a susceptor branch blade 350 relative to the central longitudinal axis of the susceptor assembly 342 (in a direction from the distal end of the susceptor branch 346 to the support 344) is greater than 0°, and when an aerosol generating article is received in the susceptor assembly 342 the angle α of the blade 350 relative to the central longitudinal axis is 0°, i.e. parallel with the central axis.

The outer ring 354 further comprises a lip 356 which is configured to sit on the wall of the heating chamber 318, and thus prevent the outer ring 354 and susceptor assembly 342 from being over-inserted into the heating chamber 318 (as can be seen in FIG. 3C).

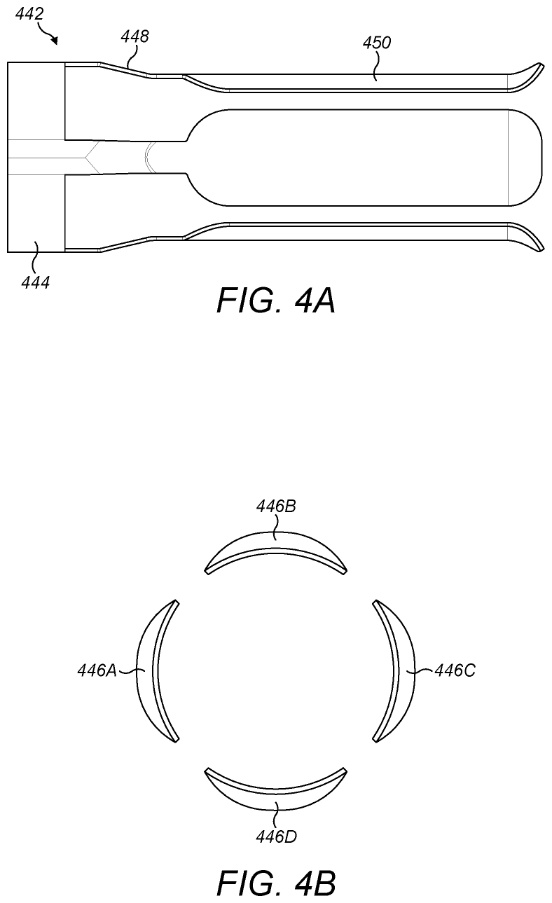

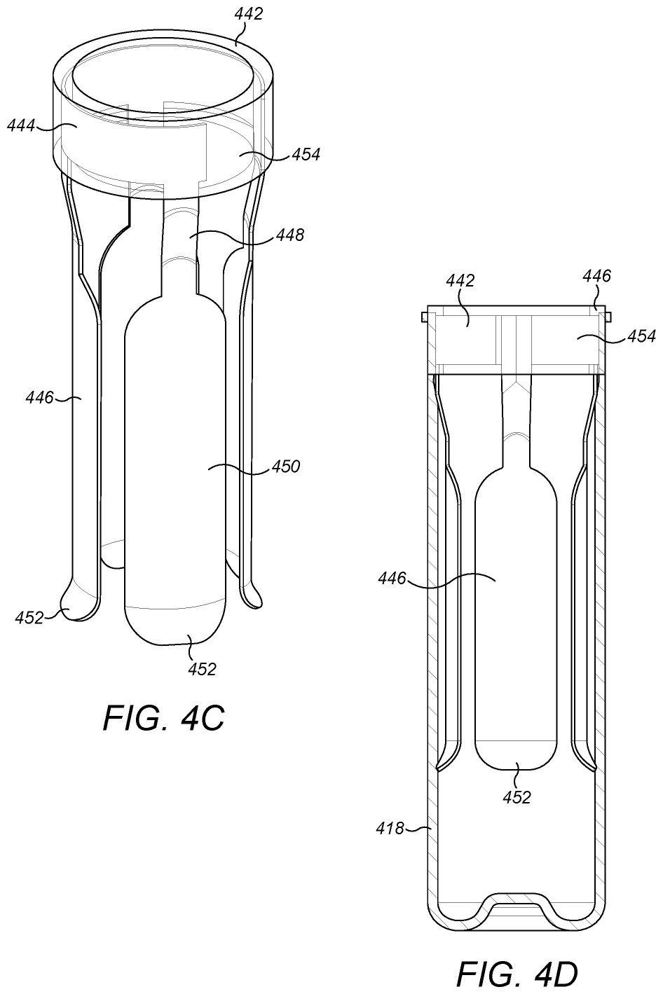

FIGS. 4A to 4D show various views of a susceptor assembly 442 according to another embodiment of the invention. FIGS. 4A and 4B show a side and mid-section view of the susceptor assembly 442 respectively, FIG. 4C shows a perspective view of the susceptor assembly 442, and FIG. 4D shows a side view of the susceptor assembly 442 within a heating chamber 418.

The susceptor assembly 442 comprises a support 444 on which susceptor branches 446A, 446B, 446C, 446D are connected. Each susceptor branch 446 comprises a stem portion 448 and a blade portion 450.

The stem 448 of each susceptor branch 446 extends inwardly toward the central longitudinal axis of the susceptor assembly 442 or heating chamber 418, as can be seen in FIG. 4A. The blade 450 of each susceptor branch 446 extends from each respective stem 448 away from the support 444 in a direction parallel to the central longitudinal axis. Each blade 450 has a pill/capsule shape, i.e. an elongated circle, and curved to form a cupped shape like a portion of a capsule.

The susceptor assembly 442 therefore has a general tulip shape, where each branch 446 (stem 448 and blade 450) can be considered like a petal of the tulip. The curvature of each blade 450 selected such that the inner surface of the blade 450 cups a received aerosol generating article.

The distal end 452 of each blade 450, or branch 446, is turned outwardly toward the side wall of the heating chamber 418 such that only the edge of the branch 446 would be in contact with the heating chamber side wall should a received aerosol generating article cause the susceptor branch 446 to flex outwardly toward the side wall. This minimises contact between the branch 446 and heating chamber 418, thereby minimising heat loss via conduction.

The susceptor assembly 442 further comprises an outer ring 454 which is moulded over the support 444, thereby providing a fully circular ring-shaped cross-section, as shown in FIG. 4C. When the susceptor assembly 442 is pressed into the heating chamber 418, the outer ring 454 provides a friction fit around its entire outer periphery with the side wall of the heating chamber 418. The outer ring 454 further comprises a lip 456 which is configured to sit on the wall of the heating chamber 418 to prevent the outer ring 454 and susceptor assembly 442 from being inserted too deeply into the heating chamber 418 (as can be seen in FIG. 4D).

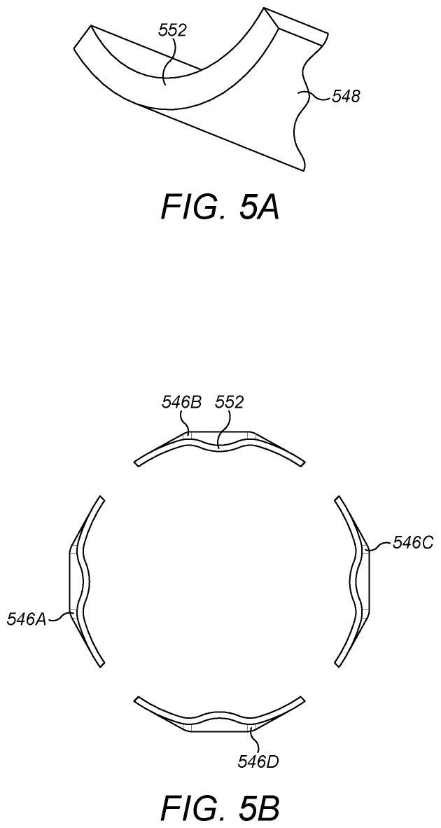

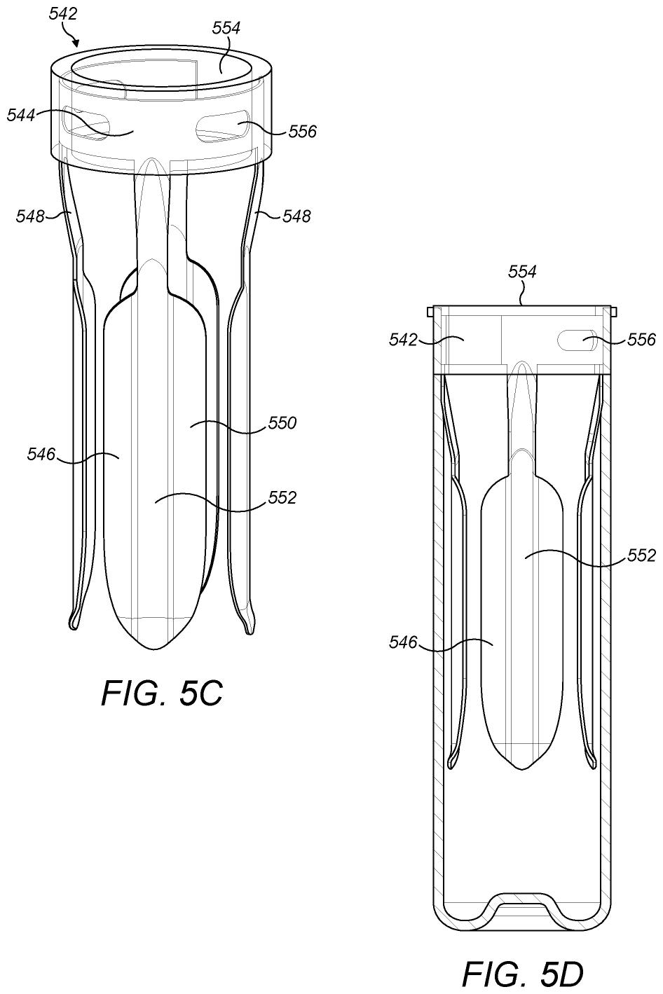

FIGS. 5A to 5D show various views of a susceptor assembly 542 according to another embodiment of the invention. FIG. 5A shows a cross-sectional perspective of the stem 548 of a susceptor branch 546, FIG. 5B shows a mid-section view of the susceptor assembly 542, FIG. 4C shows a perspective view of the susceptor assembly 542, and FIG. 5D shows a side view of the susceptor assembly 542 within a heating chamber 518.

The susceptor assembly 542 construction in FIG. 5 is similar to the embodiment described with reference to FIG. 4, where the blade 550 is pill-shaped. The susceptor assembly 542 comprises a support 544 on which susceptor branches 546A, 546B, 546C, 546D are connected. Each susceptor branch 546 comprises a stem portion 548 and a blade portion 550.

Each susceptor branch 546A, 546B, 546C, 546D comprises a curved groove 552, or rib-shape, which extends along the centre of its stem 548 and blade 550 portions. The shape of the groove 542 can be illustrated in FIG. 5A. The tip of the groove 552 points inwardly toward the centre of the susceptor assembly 542 as shown in FIG. 5B and provides structural rigidity to each branch 546. The groove 552 also provides a strip of intensified contact to a received aerosol generating article since the groove 552 would push into the side of the aerosol generating article more deeply.

The susceptor assembly 542 comprises an outer ring 554 which is moulded over the support 544, thereby providing a fully circular ring-shaped cross-section, as shown in FIG. 5C. The outer ring 454 further comprises a lip 556 which is configured to sit on the wall of the heating chamber 518 to prevent the outer ring 554 and susceptor assembly 542 from being inserted too far into the heating chamber 518 (as can be seen in FIG. 5D). The support 544 further comprises perforations 556, or holes, which optimise the connection between the support 544 and the outer ring 554 where during the forming process the material of the outer ring 554 would flow through the perforations 556 and solidify.

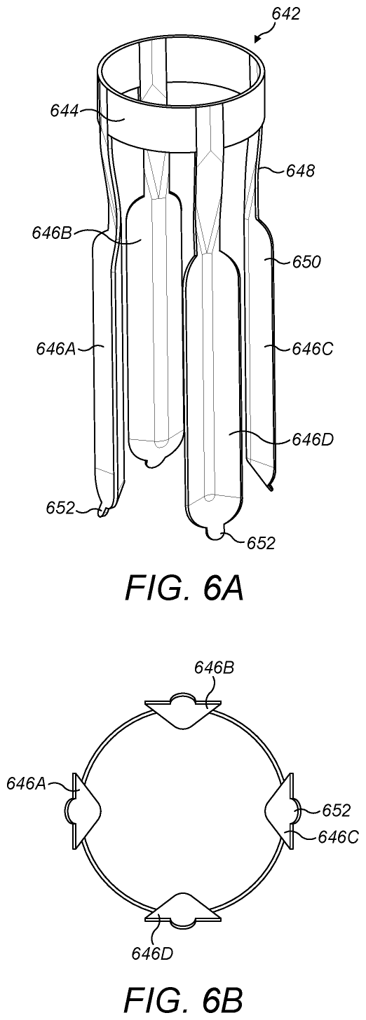

FIGS. 6A and 6B show a perspective view and an end view of a susceptor assembly 642 according to another embodiment of the invention. The susceptor assembly 642 construction in FIG. 6 is similar to the embodiment described with reference to FIG. 2. The susceptor assembly 642 comprises a support 644 on which susceptor branches 646A, 646B, 646C, 646D are connected. Each susceptor branch 646 comprises a stem portion 648 and a blade portion 650.

Each susceptor branch 646A, 646B, 646C, 646D comprises a rounded protrusion 652 which extends from the distal curved end of the branch (i.e. away from the support 644). The protrusion 652 acts to distance the main body of the susceptor branch 646 away from the side wall of a heating chamber, similar to the distal end 452 of the susceptor blade 450 in reference to the embodiment depicted in FIG. 4, which is configured to abut the side wall of a heating chamber in a minimal way to reduce heat transfer via conduction from the susceptor branches 646 to the heating chamber.

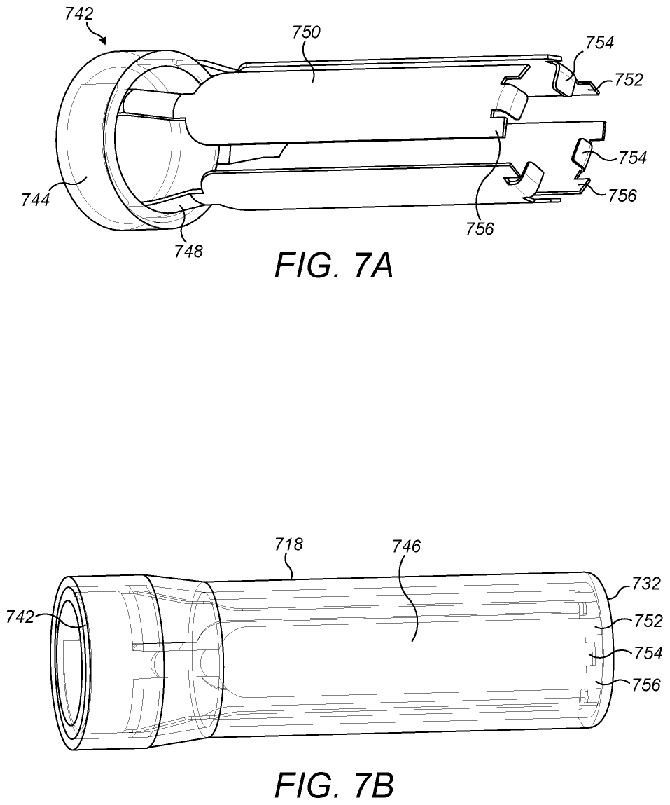

FIG. 7A shows a perspective view of the susceptor assembly 742 in another embodiment of the invention, and FIG. 7B shows a perspective view of the susceptor assembly 742 within a heating chamber 718. The susceptor assembly 742 construction in FIG. 7 is similar to the embodiment described with reference to FIG. 4. The tulip-shaped susceptor assembly 742 comprises a support 744 on which susceptor branches 746 are connected. Each susceptor branch 746 comprises a stem portion 748 and a blade portion 750.

The blade portion 750 of each susceptor branch 746 comprises a flat distal end 752 and an insertion limiter flap 754. The distal end 752 comprises two legs 756 which are arranged to abut the base 732 of the heating chamber 718.

The insertion limiter 754 is arranged to prevent an aerosol generating article from extending, or being inserted, beyond the insertion limiter 754. The insertion limiter 754 is a flap of the distal end 752 that is cut and bent inwardly toward the centre of the susceptor assembly 742. The insertion limiter flap 754 is bent such that it is substantially perpendicular to the direction of insertion of an aerosol generating substrate, such that the substrate would abut the limiter 754 in use.

When the susceptor assembly 742 is arranged in the heating chamber 718 the insertion limiter 754 and the legs 756 act to provide a gap 758 between the distal end of a received aerosol generating substrate and the base 732 of the heating chamber 718 (similar to the protrusion 220 in the embodiment described with reference to FIG. 2). The gap 758 allows air in the heating chamber 718 to be drawn up an aerosol generating substrate via its distal end, thereby optimising the delivery of generated aerosol to a user. Furthermore it can be seen in FIG. 7B that the legs 756 allow a greater length of susceptor branch along the heating chamber 718 to provide a larger heating surface.

It should therefore be understood that a heating apparatus comprising the susceptor assembly described with reference to FIG. 7 does not require a protrusion in the base of a heating chamber. FIGS. 8A and 8B show two different heating chamber according to the invention.

As can be seen FIG. 8A shows a cylindrical heating chamber 818 with an open end 820 and a closed base 822. A protrusion 824 is provided in the base 822 to provide a gap between the end of an aerosol generating substrate received within and the base 822 in order to optimise air flow and aerosol delivery in a heating apparatus.

FIG. 8B shows a cylindrical heating chamber 918 with an open end 920 and a closed base 922. The inner surface of the base 922 is rounded or flat, and would allow an aerosol generating substrate to be pushed right up against it and restrict air from flowing up the distal end of an aerosol generating substrate received in the heating chamber 918. To optimise air flow and aerosol delivery in a heating apparatus comprising heating chamber 918, the susceptor assembly would be configured to prevent an aerosol generating substrate from being inserted too deeply into the chamber 918.

It should be appreciated that any combination of the above-described features in all possible variations thereof is encompassed by the present disclosure unless otherwise indicated herein or otherwise clearly contradicted by context.

1. A heating apparatus for an aerosol generating device comprising:
a heating chamber comprising an opening arranged at a first end of the heating chamber for receiving an aerosol generating substrate; and
a susceptor assembly comprising a support and a plurality of susceptor branches extending from the support, wherein, in use, the support is positioned proximate the first end of the heating chamber and the plurality of susceptor branches extend toward a second end of the heating chamber.

2. The heating apparatus of claim 1, wherein the support comprises a susceptor.

3. The heating apparatus of claim 1, wherein the susceptor assembly is configured to be removable from the heating chamber, and further comprises a ring configured provide a frictional force which acts against an inner surface of the heating chamber, and wherein the support is arranged within the ring.

4. The heating apparatus of claim 3, wherein the support is perforated and the ring is overmoulded on the perforated support.

5. The heating apparatus of claim 1, wherein each of the plurality of susceptor branches is configured to flex toward a wall of the heating chamber when the aerosol generating substrate is received in the heating chamber.

6. The heating apparatus of claim 1, wherein a length of each of the plurality of susceptor branches is angled such that each length extends inwardly toward a central axis of the heating chamber as the respective susceptor branch extends away from the support.

7. The heating apparatus of claim 1, wherein each of the plurality of susceptor branches comprises an abutment portion configured to maintain a separation between a wall of the heating chamber and the susceptor branch when the aerosol generating substrate is received in the heating chamber.

8. The heating apparatus of claim 1, wherein each of the plurality of susceptor branches comprises a ridge.

9. The heating apparatus of claim 1, wherein one or more of the plurality of susceptor branches comprises a limiting portion configured to limit a depth to which the aerosol generating substrate can be received.

10. The heating apparatus of claim 1, wherein the heating chamber comprises a protrusion configured to prevent an aerosol generating substrate from reaching a closed end of the heating chamber.

11. The heating apparatus according to claim 1, wherein the heating chamber comprises a chamber wall configured to support an induction heating coil of an electromagnetic field generator.

12. An aerosol generating system comprising:
an aerosol generating substrate;
an electromagnetic field generator; and
a heating apparatus according to claim 1.
